(19) United States
(12) Patent Application Publication
(10) Pub. No.: US 2003/0217077 A1
(43) Pub. Date: Nov. 20, 2003

(54) Methods and apparatus for storing updatable user data using a cluster of application servers

(76) Inventors: Jeffrey D. Schwartz, Loveland, CO (US); Gary Lee Thunquest, Berthoud, CO (US)

Correspondence Address: HEWLETT-PACKARD COMPANY, Intellectual Property Administration, P.O. Box 272400, Fort Collins, CO, 80527-2400, US

(21) Appl. No.: 10/150,123

(22) Filed: May 16, 2002

(51) Int. Cl. G06F 17/30

(52) U.S. Cl. 707/200

(57) ABSTRACT

A method for storing updatable user data using a cluster of application servers includes: storing updateable user data across a plurality of the application servers, wherein each application server manages an associated local storage device on which resides a local file system for storage of the user data and for metadata pertaining thereto; receiving a point-in-time copy (PTC) request from a client; freezing the local file systems of the plurality of clustered application servers; creating a PTC of the metadata of each frozen local file system; and unfreezing the local file systems of the plurality of clustered application servers.

### FIELD OF THE INVENTION

The present invention relates to file storage in clusters of application servers, and more particularly to methods and apparatus for maintaining integrity of and backing up updatable user data in clusters of application servers.

### BACKGROUND OF THE INVENTION

Referring to FIG. 2, in prior art cluster configurations 24 of application servers, application servers such as 12A, 12B, 12C, 12D, and 12E are operatively coupled to a storage area network 26, each via a dedicated connection such as Fibrechannel connections 28A, 28B, 28C, 28D, and 28E. Each application server in cluster configuration 24 shares common user storage within a storage area network (SAN) 26. In configuration 24, the management of user storage is left to SAN 26. This configuration allows all application servers 12A, 12B, 12C, 12D, and 12E to access the same user data and ensures that updated user data stored on volumes in SAN 26 is available simultaneously to all of the application servers. Backups can be made by freezing the file systems on SAN 26.

Configurations similar to cluster configuration 24 have proven satisfactory in use, but are somewhat costly as a result of the need for dedicated Fibrechannel connections and a SAN separate from the application servers. Moreover, in most cases, there is unused bandwidth available on an Ethernet network 14 that connects the application servers to each other and to clients, such as clients 18 and 20, that make requests concerning updatable user data and receive answers pertaining to such data via network 14. However, SANs presently either do not communicate or are not configurable at present to take advantage of networks such as Ethernet network 14 in configurations such as configuration 24 of FIG. 2.

### SUMMARY OF THE INVENTION

One configuration of the present invention therefore provides a method for storing updatable user data using a cluster of application servers. The method includes: storing updateable user data across a plurality of the application servers, wherein each application server manages an associated local storage device on which resides a local file system for storage of the user data and for metadata pertaining thereto; receiving a point-in-time copy (PTC) request from a client; freezing the local file systems of the plurality of clustered application servers; creating a PTC of the metadata of each frozen local file system; and unfreezing the local file systems of the plurality of clustered application servers.

Another configuration of the present invention also provides a method for storing updatable user data using a cluster of application servers. In this method, at least one of the application servers is a point-in-time (PTC) managing server that does not store updatable user data. Also, at least a plurality of the application servers are non-managing application servers that do store updatable user data. The method includes: maintaining, in the PTC managing server, a local copy of metadata pertaining to user data stored in the non-managing application servers of the cluster in a memory local to the PTC managing server, storing updatable user data across a plurality of non-managing application servers in file systems of associated local storage devices; maintaining, in each non-managing application server, a local copy of metadata pertaining to user data stored in the file system of the associated local storage device; receiving a PTC request from a client; and creating a PTC of the metadata in the PTC managing server.

Yet another configuration of the present invention provides an apparatus for storing updatable user data and for providing client access to an application. This apparatus includes: a plurality of application servers interconnected via a network, each application server having an associated local storage device on which resides a local file system; and a router/switch configured to route requests received from clients to the application servers via the network. Each application server is configured to manage the associated local storage device to store updatable user data and metadata pertaining thereto, and, in response to requests to do so: to freeze its local file system, to create a point-in-time copy of the metadata of its local file, and to unfreeze its local file system. Also, at least one of the application servers is configured to be responsive to a point-in-time (PTC) request from a client to signal, via the network, for each application server to freeze its local file system, to create a PTC of the metadata of its local file system, and to unfreeze its local file system.

Still another configuration of the present invention provides an apparatus for storing updatable user data and for providing client access to an application. The apparatus includes: a plurality of application servers interconnected via a network, each application server having an associated local storage device on which resides a local file system; and a router/switch configured to route requests received from clients to the application servers via the network. At least one of the application servers is a point-in-time copy (PTC) managing server and a plurality of remaining application servers are non-managing servers. The PTC managing server is configured to retain a local copy of metadata pertaining to user data stored in the non-managing application servers of the cluster in a memory local to the PTC managing server. In addition, the apparatus is configured to store updatable user data across a plurality of the non-managing application servers in file systems of associated local storage devices; the non-managing application servers are configured to manage a local copy of metadata pertaining to user data stored on the file system of the associated local storage device; and the apparatus is further configured to receive a PTC request from a client and to create a PTC of the metadata in the PTC managing server.

It will become apparent that configurations of the present invention effectively utilize excess capacity in a network used for communication of update requests and answers to and from application servers and do not require a separate network or communication channel (such as Fibrechannel connections) between a storage network and the application servers. Configurations of the present invention also permit clients to access the same user data without requiring each application server to maintain a complete copy of all user data and facilitate backups of user data as well as recovery from errors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of one configuration of the present invention.

FIG. 2 is a block diagram of a cluster of application servers utilizing a storage area network for storage of user data, as in the prior art.

FIG. 3 is a flow chart representing the operation of one configuration of the present invention.

FIG. 4 is a block diagram showing the relationships of files, file segments, and portions of file segments in one configuration of the present invention.

FIG. 5 is a block diagram showing a suitable manner in which portions of file segments and checksums are stored across a plurality of application servers in one configuration of the present invention.

FIG. 6 is a block diagram representing the allocation of blocks in a file system after a point-in-time copy of the metadata of a file system is made.

FIG. 7 is a flow chart representing the operation of another configuration of the present invention.

Each flow chart may be used to assist in explaining more than one configuration of the present invention. Therefore, not all of the features shown in the flow charts and described below are necessary to practice some configurations of the present invention. Additionally, some functions shown as being performed sequentially in the flow charts and not logically needing to be performed sequentially may be performed concurrently. In addition, some of the steps shown in the flow charts may represent steps performed using different processors.

### DETAILED DESCRIPTION OF THE PREFERRED EMBODIMENTS

The following description of the preferred embodiment(s) is merely exemplary in nature and is in no way intended to limit the invention, its application, or uses.

“Point in time copies” permit system administrators to freeze the current state of a storage volume. This process takes just a few seconds and the result is a second volume that points to the same physical storage as the first volume, and which can be mounted with a second instance of the same file system that was used to mount the original volume.

“Volumes” are a group of physical or virtual storage blocks that are presented to the file system as the location at which data is to be placed when storing user files. Control of these storage blocks is given to a file system, so that the file system has complete control over the content of each block. The locations of content blocks and overhead blocks are defined by the particular file system that mounts the volume. Each volume is controlled by a single instance of a file system.

A “clustered system” has one or more server computers operating as a system that may or may not have a single presentation to clients, depending upon the cluster implementation design choice. As used herein, a “node” is a single computer in a clustered system. In the configurations described herein, many or all of the nodes are application servers. Also as used herein, a “cluster” refers to all of the nodes of a system.

A clustered file system is similar to a standard file system in that it interfaces with the virtual file system (VFS) layer of the operating system running on the CPU controlling a node. Thus, applications that run on a node access data using the same technique whether the file system is a cluster file system or a stand alone file system, although the data accessed by a node may or may not be located on locally attached storage in a cluster file system. Nevertheless, in a cluster file system, metadata that define where the user data objects reside is located on each of the nodes participating in the cluster. Thus, there can be multiple instances of the file system operating on the same data.

Each node in a cluster has one instance of the file system running and may or may not have storage that holds user data objects. Disk blocks can reside on storage that is directly attached to the node operating the file system or they can be located on storage that is locally attached to a cluster node through the networking infrastructure.

When a file system starts, it is told to mount some type of a volume. This volume presents the file system a series of data blocks that are to be used by the file system for storing and organizing data entrusted to the file system by users. To mount a volume, each file system looks in a predefined location in storage for an information block that tells the file system the location of the root directory information, and from there, where all the files are located. This information is called the “superblock” in traditional file systems. In a clustered file system, the information may or may not be contained within a disk block. As used herein, the term “super-object” refers to this information and its container, whether the container is a single superblock or not.

Information contained in the superblock or super-object is defined by the file system that is able to mount the volume. The file system for which the super-object is intended understands and can find the superobject. A metadata system, which comprises a super-object and an entire directory and file information tree, is located on each node of the cluster, whether the node manages storage for the cluster or is only a cluster member that can interpret (or at least recognize) metadata.

Each instance of the file system communicates its activity to each of the other file system instances in a cluster to ensure that there is a complete set of metadata located at each node, as all nodes in a cluster mount the same volume to access the same data blocks that hold user data files. Therefore, each node modifies and communicates this information to each of the other nodes.

A process referred to as PTC (Point in Time Copy) and another referred to CWPTC (Cluster Wide Point in Time Copy) together create a copy of an Original VOLume's (OVOL) metadata system so that the content of the two volumes can change independently of each other. This Copy of the original VOLume (CVOL) contains the same data as the OVOL at the instant the process of copying the OVOL to the CVOL is complete, i.e., both the CVOL and OVOL metadata systems point to the same physical data. As access to the volumes resume, the data contained in the OVOL and the CVOL will diverge.

PTC is used with file systems that utilize a single copy of the metadata and each node in a cluster communicates with a central metadata node to locate user data. On the other hand, CWPTC is used with a file system that synchronizes a copy metadata at each node in a cluster.

In one configuration, a single node performs a PTC on its metadata system. After the operation completes, the node distributes the PTC to all of the other nodes in the system. After each node receives that metadata information and has provided any necessary local conversions, the cluster can allow it to be used.

In another configuration, a signal is sent to each node to perform a CWPTC. Each copy of the metadata on the cluster is made current before the operation starts. Each node then suspends all change transactions and waits for a response from each of the other nodes in the cluster confirming that there are no other change transactions pending. After the appropriate confirmations are received, each node performs a PTC operation on its metadata. Once this operation completes, change transactions are allowed to resume. In one variation of this configuration, a queuing prioritization system is utilized to make data available for change partway through the PTC operation.

PTC operations can be performed every hour or so in very large clusters. In such configurations in which speed is important, the signaling (as opposed to the distributing) configuration avoids the necessity of communicating with all cluster nodes, which may require a substantial amount of time. In addition, as the data changes, synchronization of the PTC on a node in the distributing configuration will become a longer process. The signaling configuration scales into larger systems, because the data changes in parallel in a distributed processor fashion.

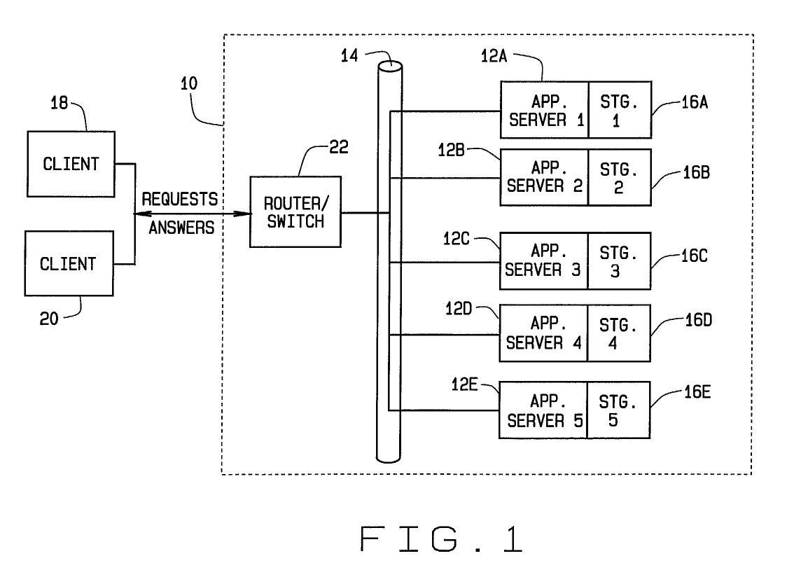

In one configuration and referring to FIG. 1, an apparatus 10 is provided for storing updatable user data and for providing client access to an application. Apparatus 10 comprises a cluster of at least two application servers. In the illustrated configuration, five application servers 12A, 12B, 12C, 12D, and 12E are provided. Each application server is a stored program processor comprising at least one processor or CPU (not shown) executing stored instructions to perform the instructions required of the application and the functions described herein as part of the practice of the present invention. Application servers 12A, 12B, 12C, 12D, and 12E are interconnected by a network 14, for example, an Ethernet network. Each application server 12A, 12B, 12C, 12D, and 12E is provided with a local storage device 16A, 16B, 16C, 16D and 16E, respectively, on which resides a local file system controlled by the respective application server. Each local storage device 16A, 16B, 16C, 16D, and 16E comprises, for example, a hard disk drive or other alterable storage medium or media. (In a configuration in which an application server is provided with a plurality of alterable storage media, such as two or more hard disk drives, the term “local storage device” is intended to refer to the plurality of storage media collectively, and the “local file system” to the one or more file systems utilized by the collection of storage media.)

Clients, such as clients 18 and 20, communicate with application servers 12A, 12B, 12C, 12D, and/or 12E utilizing a router/switch 22. Router/switch 22 is configured to route requests pertaining to the application or applications running on servers 12A, 12B, 12C, 12D and 12E to a selected one of the servers. The selection in one configuration is made by router/switch 22 based on load balancing of the application servers. Application servers 12A, 12B, 12C, 12D, and 12E are, for example, file servers, database servers, or web servers configured to respond to requests from clients such as 18 and 20 with answers determined from the user data in accordance with the application running on the application servers. In one configuration, application servers 12A, 12B, 12C, 12D and 12E all run the same application and are thus the same type of server. The invention does not require, however, that each application server 12A, 12B, 12C, 12D and 12E be the same type of server, that each application server be the same type of computer, or even that each application server comprise the same number of central processing units (CPUs), thus allowing configurations of the present invention to be scalable.

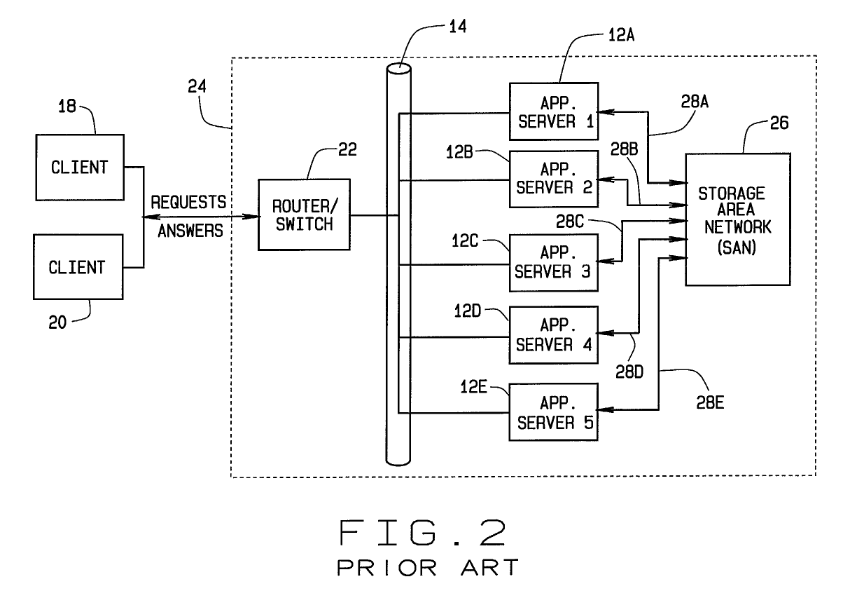

The configuration of FIG. 1 is to be distinguished from the relatively more expensive prior art cluster configuration 24 shown in FIG. 2. In the prior art configuration, application servers such as 12A, 12B, 12C, 12D, and 12E are operatively coupled to a storage area network (SAN) 26 via dedicated Fibrechannel connections 28A, 28B, 28C, 28D, and 28E. This configuration is topologically distinct from cluster configuration 10 shown in FIG. 1 in that the application servers in cluster configuration 24 of FIG. 2 share common user data memory within SAN 26 and certain types of control information concerning point-in-time (PTC) copy management are not communicated between different application servers (for example, between application server 12A and 12D). Instead, file system data and file backup is managed by SAN 26. On the other hand, cluster configuration 10 of FIG. 1 requires neither the separate Fibrechannel connections 28A, 28B, 28C, 28D, and 28E nor the SAN 26 that is required by configuration 24 of FIG. 2.

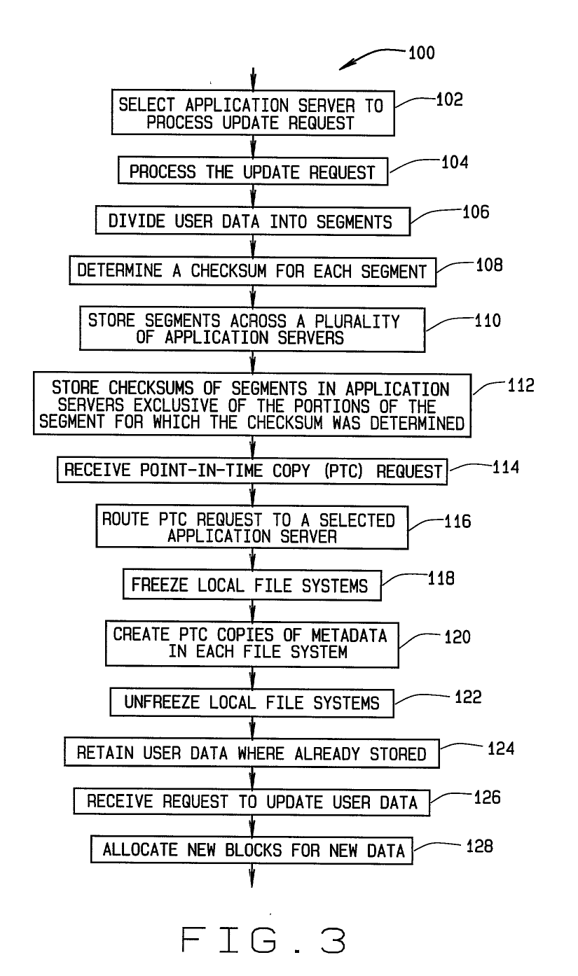

Flow chart 100 of FIG. 3 is representative of one configuration of a method for operating cluster configuration 10 of FIG. 1. Referring to FIGS. 1, and 3 when an update request is received from a client such as client 18, router/switch 22 selects 102 one of the application servers, for example, application server 12B, to process 104 the request. (As used herein, an “update request” refers to any request that requires a change or addition to data stored in a storage device. Thus, a request to store new data, or a request that is serviced by storing new data, is included within the scope of an “update request,” as are requests to change existing data, or requests that are serviced by changing existing data. In one configuration, update requests include user data to be stored.) The steps taken by an application server to process a request vary depending upon the nature of the request and the type of application server. Also, in one configuration, the selection of application server varies with each request and is determined on the basis of a load-balancing algorithm to avoid overloading individual servers.

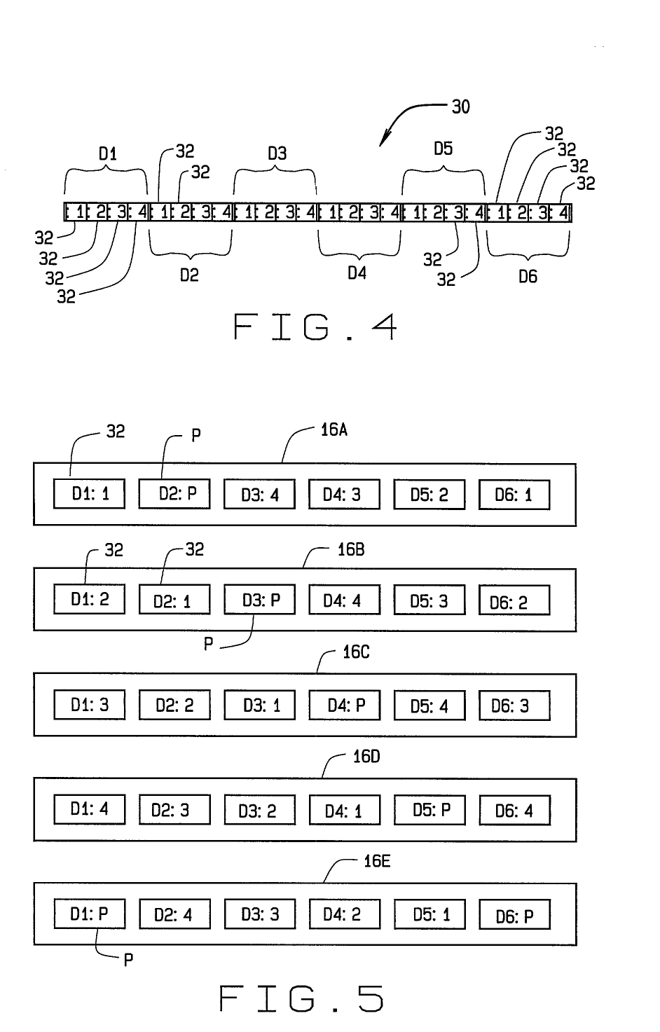

In one configuration, and referring to FIGS. 1, 3, and 4, user data comprises files 30 of data, which are divided 106 into segments D1, D2, D3, D4, D5, and D6. The length of a segment is a design choice, but is preselected to permit efficient calculation of checksums. The number of segments in a file may vary depending upon the selected length of the segment and the length of the file of user data. It is not necessary that all segments be of equal length. In particular, the final segment (in this case, D4) may not be as long (i.e., contain as many bits or bytes) as the other segments, depending upon the length of the divided file 30. In one configuration, however, the final segment is padded, for example, with a sufficient number of zeros to ensure that each segment has equal length. A checksum P (not shown in FIG. 4) is determined 108 for each segment. Portions 32 of the segments are stored 110, in one configuration, across a plurality of the application servers. (Not all portions 32 are indicated by callouts in FIG. 3.) The checksums for each segment are stored 112, also in one configuration, in one of the application servers exclusive of the portions of the segment for which the checksum was determined. Referring to FIGS. 3 and 5, one configuration utilizes N application servers and there are N−1 portions in each segment. For example, one configuration utilizes five, application servers and there are four portions (indicated by numbers 1, 2, 3, 4 preceded by a colon) in each segment. Each of the four portions :1, :2, :3, and :4 of an individual segment is stored in a different application server, so that the user data is stored across a plurality of application servers. In the configuration illustrated in FIG. 5, application servers and their associated storage devices 16A, 16B, 16C, 16D, 16E are used to store portions of individual segments D1, D2, D3, D4, D5, and D6, and the portions 32 of these segments stored by the application servers are systematically rotated. Checksums P of each segment is stored in a application server exclusive of the segment (i.e., none of the data segment portions are stored in the application server used to store the checksum.) In this manner, the storing 112 of checksums for consecutive segments in a file are rotated amongst the N application servers. For example, application server 12B and associated local storage device 16B stores portion :2 of segment D1, portion :1 of segment D2, portion :4 of segment D4, portion :3 of segment D5, and portion :2 of segment D6. Application server 12B does not store a portion of segment D3, but it does store the parity for segment D3, exclusive of any of its segments. The rotation of segment portions and checksums across a plurality of application servers in this manner contributes to the efficient recovery of data should one of the file systems or application server hardware fail. Rotation systems such as that illustrated in FIG. 5 are known in RAID (redundant array of inexpensive disk) storage systems, but is believed to be novel as described above as used across a plurality of different application servers that together comprise a cluster. (It should be noted that a final segment of a file may not contain sufficient data to be divided into the same number of portions as other segments of a file, but padding of the segment can be used, if necessary, to equalize segment lengths, if required in a particular configuration of the invention.)

As update requests continue to be received, user data stored in application servers 12A, 12B, 12C, 12D, and 12E will change with time. Eventually, it will become necessary or at least advantageous to make a backup copy of the user data. Backups may be initiated automatically (e.g., using a “cron”-type scheduling program) or manually. However, it is also necessary or at least advantageous to allow user data to continue to be updated while a backup is in progress, as the amount of user data may be considerable and the time required for a backup may be large. For the present example, let us assume that a backup request is manually initiated by an administrator utilizing client 20. Referring again to FIGS. 1 and 3, a request to make a point-in-time copy (PTC) is received 114 from a client. The request could also be made by an administrator at a keyboard or terminal local to an application server. This request is directed 116 by router/switch 22 to a selected application server, for example, application server 12D. The manner in which this selection is made is not important to the invention in the present configuration. For example, the application server to be selected for receiving PTC requests may be random, selected according to load-balancing criteria, or selected systematically utilizing other criteria or in a preselected sequence. (It is also possible for an administrator to make a PTC request at a terminal or keyboard local to an application server, or for a “cron”-type program local running in one of the application servers to make such a request. In either of these cases, the application server having the local terminal or keyboard, or the application server running the “cron”-type program may designate itself as the selected application server.) Selected application server (e.g., 12D) then freezes 118 the local file systems of the cluster of application servers 12A, 12B, 12C, 12D, and 12E. In doing so, selected application server 12D freezes its own local file system in its associated local storage device 16C, and issues a message via network 14 (the same network utilized for transmission of user data update requests) to the other application servers 12A, 12B, 12C, and 12E to freeze their own file systems. In this manner, application server 12D (i.e., the selected application server) becomes a controller. In one configuration, transactions pending at the time of the freeze request are completed, but new requests are suspended. In another configuration, a queuing system is provided to allow data to be available to clients once the PTC operation is complete for a requested item of user data.

Controlling application server 12D then creates 120 a point-in-time copy (i.e., a “PTC,” sometimes also referred to as a “PTC copy”) of the metadata of its own file system and sends a request to each other application server 12A, 12B, 12C, and 12E to create a PTC of the metadata in their own file systems. (In another configuration, each application server eligible to be used as a controlling application server keeps metadata for each filesystem of each application server in its own storage. Translation routines are provided, if necessary, to allow eligible controlling application servers to perform the PTC operation itself and to distribute the information to each of the other application servers in the cluster in an format native to the other application servers.) After the PTCs are made and an answer received by controlling application server 12D from each of the other application servers 12A, 12B, 12C, and 12E, the local file system of controlling application server 12D is unfrozen 122, and a message is sent to each other application server 12A, 12B, 12C, and 12E to unfreeze their file systems. In this manner, controlling application server 12D serves to synchronize the freezing of the local file systems on each application server, the creating of the copy of the metadata, and the unfreezing of the local file systems. Controlling application server 12D may thus also be considered as a synchronizing server for these purposes.

While the file systems are frozen, newly received requests from clients to update user data stored in the local file systems are either stalled or rejected, and a message indicating that the request was stalled or rejected, respectively, is transmitted by the server receiving the request to the client making the request via network 14 and router/switch 22. Requests from clients to update user data on the local file systems may be pending at the time the local file systems are frozen. If so, the pending requests are either serviced or flushed and a message indicating that the request was serviced or flushed is transmitted by the server receiving the request to the client making the request via network 14. In some cases, communication between two or more application servers 12A, 12B, 12C, 12D, and 12E may be required to determine the type of answer to be sent back to the client, and/or a server other than the one receiving the update request may be utilized to transmit the answer back to the client. In at least one configuration, it is contemplated that the amount of time the file systems are frozen may be significant, and that the choice of whether to service or flush a pending request and/or to stall or reject a newly received request may depend upon the nature of the application server, the robustness of the application running on the application servers and the clients, and the impatience of users. Clients 18, 20 may include functions that appropriately handle various these situations or may request user input when such situations occur.

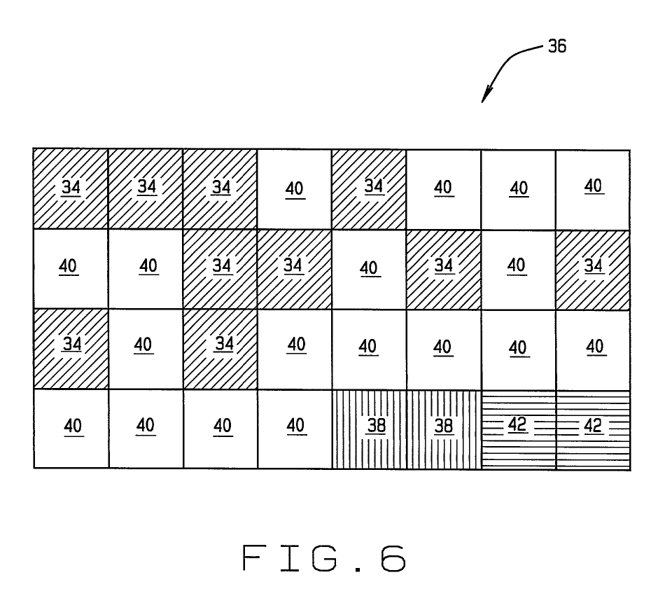

The PTC of the metadata stored on each application server facilitates backing up of the user data stored across all of the file servers. In particular, and referring once again to FIG. 3 and additionally to FIG. 6, after a PTC of metadata in each file system is made, user data 34 stored in each file system 36 at the time of the freeze request is retained 124 in locations in which it is already stored. Thus, the PTC of the metadata 38 in that file system can be used to locate this already stored user data. After the file systems are unfrozen, when a request to update the user data in the file system is received 126, one or more new, unallocated blocks 40 of the file system are allocated 128 and a “live” copy of the metadata 42 is updated to reflect the new allocation. More than one PTC of the metadata 38 may exist at one time. Therefore, to ensure that only unallocated blocks are used for the updated user data, in one configuration, the file system checks not only the live copy 42 of the metadata, but all other PTCs 38 of the metadata that have not yet been dismissed or deleted. In the meantime, any backup of user data utilizes the PTC of the metadata 38 for each file system (or, if more than one PTC exists, a designated PTC for each file system, wherein each designated copy in each file system were produced in response to the same PTC request). In one configuration, the PTC (or a designated PTC) of the metadata is used to backup retained user data as it was current at the time of the PTC request to a device local to one of the application servers. In another configuration, the device used to backup the retained user data is local to a client. Also in one configuration, the retained user data is transmitted to the backup device from the local file system on the application server directly via network 14, the same network carrying the update requests. A PTC of metadata can be dismissed or deleted when it is no longer needed. Any blocks containing user data that has not yet been updated will be known in the “live” copy of the metadata, as will blocks containing updated user data, so the deletion of the PTC will not adversely affect any user data, except older data that is no longer needed. Such older data will be in blocks indicated as being in use only in PTCs. If a block is not indicated as containing stored data by a remaining PTC of metadata or by the “live” copy of the metadata, that block can be reallocated for updated user data.

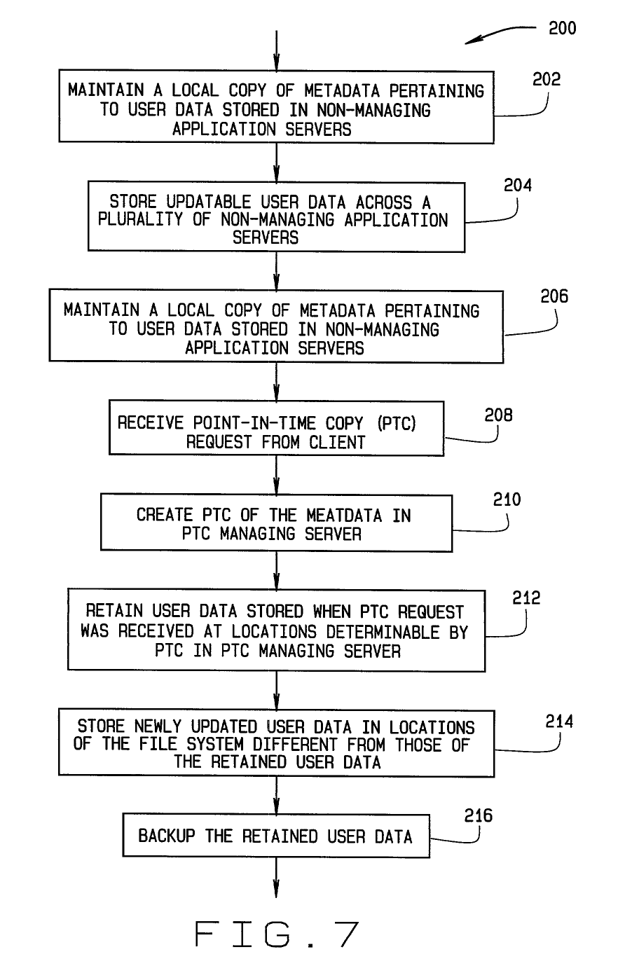

FIG. 7 is a flow chart 200 that represents the operation of another configuration of the present invention in which either one, or at least one but less than all application servers in a cluster act as a point-in-time copy (PTC) managing server. In one configuration and referring to FIGS. 1 and 7, one application server (for example, 12D) in cluster 10 is preselected as a point-in-time copy (PTC) managing server. PTC managing server 12D is not required to store user data in a file system and need not include an associated local storage device (in this example, 16D), but an associated local storage device 16D or other storage apparatus (not necessarily local) may be provided for other purposes relating to its use as an application server. Additional PTC managing servers are preselected in another configuration, but each configuration utilizes a plurality of non-managing application servers (i.e., application servers that do not act as PTC managing servers and that store updatable user data).

In the configuration described by FIG. 1, PTC managing server 12D maintains 202 a local copy of metadata pertaining to user data stored in the non-managing application servers 12A, 12B, 12C, 12E in the cluster in a memory (for example, storage device 16D or a RAM or flash memory not shown in the figures) local to PTC managing server 12D. The local copy of metadata includes sufficient information for PTC managing server 12D to locate user data requested by a client 18 or 20. Such information includes, for example, the non-managing application server on which requested user data is stored and sufficient information for that non-managing application server to locate the requested data. The information may also include additional information, for example, information about access rights, but such additional information is not required for practicing the present invention. Updatable user data is stored 204 across a plurality of non-managing application servers 12A, 12B, 12C, and 12E in file systems of their associated local storage devices 16A, 16B, 16C, and 16E, respectively. In one configuration, the functions of maintaining 202 the metadata in the PTC managing server and the storing 204 of updatable user data in the non-managing application servers are performed concurrently. Non-managing application servers 12A, 12B, 12C, and 12E also each maintain 206 a local copy of the metadata pertaining to the user data stored in the file systems of associated local storage devices 16A, 16B, 16C, and 16E, respectively. Local metadata copies stored in non-managing application servers need not maintain information about user data stored in other non-managing application servers, and the local metadata copies need not contain all of the information contained in the metadata copy maintained by PTC managing server 12D. When a point-in-time copy (PTC) request is received 208 from a client, such as client 18, PTC managing server 12D creates 210 a PTC of the metadata in that server.

In one configuration, maintenance functions 202 and 206 are performed routinely as update requests are transmitted from clients and as answers from the application servers are each routed via an Ethernet network. Information relating to the update requests is also transmitted and received between the non-managing application servers and the PTC managing application server via the same Ethernet network to facilitate these maintenance functions. Also in one configuration, the user data comprises files which are segmented, with checksums determined for each segment, and N−1 portions for each segment that is not a final segment are rotated with the checksum amongst N non-managing application servers.

Also in one configuration, user data stored when a PTC request was received is retained 212 at locations determinable utilizing the PTC of the metadata in the PTC managing server. For example, the data already stored simply remains in place. Any further update request results in storing 214 the further updated user data in locations of the file system different from those of the retained user data. For example, a non-managing application servers 12A would allocate a new block for any changed data, which would be reflected in the maintained copies of the metadata in the non-managing application server 12A and the PTC managing server 12D. The user data stored at the time the PTC request was made is backed up 216 utilizing the PTC of the metadata in the PTC managing server to access the retained user data. The backup, for example, is to a storage device on a client 18 or 20 or to some other device communicating with the Ethernet network. After the backup is made, the PTC of the metadata in the PTC managing server can be discarded or deallocated. In one configuration, more than one PTC of the metadata in the PTC managing server is permitted to exist. Also in one configuration, the PTC managing server and the non-managing servers coordinate the storage 214 of newly updated user data using the PTC of the metadata, so that only new, unallocated blocks of storage are allocated for the updated user data and retained data is not overwritten.

In multi-server configurations of the present invention such as those described above, clients 18, 20 directly or indirectly request data twice. A first request originates at a client and is targeted at a first server. The second request originates at the first server, and the second request is targeted at a second server that stores the first part of a user data file. If the first server has a copy of the information that is not marked as being out of date, access to the second server is not required, thereby resulting in a performance improvement. In addition, a caching strategy may be used that is self-learning and self-managing. Most caches gather data based on access frequency. This strategy can be improved in configuration of the present invention by keeping track of metrics such as type of access, frequency of access, and location of access. Intelligent decisions can be made about particular data to decrease the cold cache hit rate.

It will thus be seen that a CWPTC process is provided that performs a PTC on a single node and then distributes the information to the remaining nodes in a cluster. Also provided is a CWPTC process that performs a PTC on each node by electing a control node (i.e., a PTC managing server), and that control node communicates to each cluster node (i.e., a non-managing server), for zero outstanding transactions before initiating a PTC for each node. Once each node is finished, the elected node will restart change transactions.

Configurations of the present invention effectively utilize excess bandwidth in a network used for communication of update requests and answers to and from application servers and do not require a separate network or communication channel (such as Fibrechannel connections) between a storage network and the application servers. However, the use of such a separate network is not precluded by the invention, and a separate network is used in one configuration not illustrated in the accompanying figures. Configurations of the present invention also permit clients to access the same user data without requiring each application server to maintain a complete copy of all user data and facilitate backups of user data as well as recovery from errors. Furthermore, CWPTC methods and apparatus are provided that have little or nor effect on data availability.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for storing updatable user data using a cluster of application servers, said method comprising:
storing updateable user data across a plurality of said application servers, wherein each said application server manages an associated local storage device on which resides a local file system for storage of the user data and for metadata pertaining thereto;
receiving a point-in-time copy (PTC) request from a client;
freezing the local file systems of the plurality of clustered application servers;
creating a PTC of the metadata of each of the frozen local file systems; and
unfreezing the local file systems of the plurality of clustered application servers.

2. A method in accordance with claim 1 further comprising selecting and utilizing one of the clustered application servers to synchronize the freezing of the local file systems, the creating of the copy of the metadata, and the unfreezing of the local file systems, the utilized application server thereby becoming a synchronizing server.

3. A method in accordance with claim 2 further comprising at least one of rejecting or stalling newly received requests from clients to update user data stored on the local file systems while the local file systems are frozen.

4. A method in accordance with claim 3 further comprising at least one of servicing or flushing requests from clients to update user data stored on the local file systems pending at a time when the local file systems are frozen.

5. A method in accordance with claim 2 further comprising at least one of servicing or flushing requests from clients to update user data stored on the local file systems pending at a time when the local file systems are frozen.

6. A method in accordance with claim 2 further comprising receiving a request from a client to update user data while the local file systems are frozen, updating the local file systems and metadata of one or more of the application servers in accordance with the update request utilizing unallocated memory in the local file systems, and retaining unaltered user data in portions of the local file systems allocated at the time the local file systems were frozen and an unaltered PTC of the metadata of the file systems.

7. A method in accordance with claim 2 further comprising routing update requests transmitted from clients and answers from application servers to clients via an Ethernet network, and transmitting and receiving synchronization requests and responses from the synchronizing application server to other said application servers via the same Ethernet network.

8. A method in accordance with claim 2 wherein the application servers are selected from the group consisting of file servers, database servers, and web servers.

9. A method in accordance with claim 2 wherein the application servers are all file servers.

10. A method in accordance with claim 2 wherein the application servers are all database servers.

11. A method in accordance with claim 2 wherein the application servers are all web servers.

12. A method in accordance with claim 2 wherein the user data comprises files, and said storing updateable user data across a plurality of said application servers comprises dividing at least some files into a plurality of segments, and storing portions of said segments across more than one said application server.

13. A method in accordance with claim 12 further comprising determining a checksum for each said segment, and storing said checksum in a file system of an application server exclusive of the portions of the segment for which the checksum was determined.

14. A method in accordance with claim 13 wherein the number of application servers is N, and the number of portions in each said segment that is not a final segment is N−1.

15. A method in accordance with claim 14 further comprising rotating the storing of said checksums for consecutive said segments amongst the N application servers.

16. A method in accordance with claim 2 further comprising retaining user data stored when a PTC request was received at locations in file systems at which the retained user data is already stored;
storing further updated user data in locations in the file systems different from those of the retained user data; and
backing up the stored user data utilizing the PTCs of the metadata to access the retained user data.

17. A method for storing updatable user data using a cluster of application servers, at least one of which is a point-in-time (PTC) managing server that does not store updatable user data and at least a plurality of which are non-managing application servers that do store updatable user data, said method comprising:
maintaining, in the PTC managing server, a local copy of metadata pertaining to user data stored in said non-managing application servers of said cluster in a memory local to said PTC managing server,
storing updatable user data across a plurality of non-managing application servers in file systems of associated local storage devices;
maintaining, in each non-managing application server, a local copy of metadata pertaining to user data stored in the file system of the associated local storage device;
receiving a PTC request from a client; and
creating a PTC of the metadata in the PTC managing server.

18. A method in accordance with claim 17 further comprising routing update requests transmitted from clients and answers from application servers via an Ethernet network, and transmitting and receiving metadata information relating to the update requests between the non-managing application servers and the PTC managing application server via the same Ethernet network.

19. A method in accordance with claim 17 wherein the application servers are selected from the group consisting of file servers, database servers, and web servers.

20. A method in accordance with claim 17 wherein the application servers are all file servers.

21. A method in accordance with claim 17 wherein the application servers are all database servers.

22. A method in accordance with claim 17 wherein the application servers are all web servers.

23. A method in accordance with claim 17 wherein the user data comprises files, and said storing updateable user data across a plurality of said non-managing application servers comprises dividing at least some files into a plurality of segments, and storing portions of said segments across more than one said non-managing application server.

24. A method in accordance with claim 23 further comprising determining a checksum for each said segment, and storing said checksum in the file system of an non-managing application server exclusive of the portions of the segment for which the checksum was determined.

25. A method in accordance with claim 24 wherein the number of non-managing application servers is N, and the number of portions in each said segment that is not a final segment is N−1.

26. A method in accordance with claim 25 further comprising rotating the storing of said checksums for consecutive said segments amongst the N non-managing application servers.

27. A method in accordance with claim 17 further comprising:
retaining user data stored when a PTC request was received at locations determinable utilizing the PTC of the metadata in the PTC managing server;
storing further updated user data in locations of the file systems different from those of the retained user data; and
backing up the retained user data utilizing the PTC of the metadata in the PTC managing server to access the retained user data.

28. An apparatus for storing updatable user data and for providing client access to an application, said apparatus comprising:
a plurality of application servers interconnected via a network, each said application server having an associated local storage device on which resides a local file system; and
a router/switch configured to route requests received from clients to said application servers via said network;
wherein each said application server is configured to manage the associated local storage device to store updatable user data and metadata pertaining thereto, and, in response to requests to do so:
to freeze its local file system,
to create a point-in-time copy of the metadata of its local file, and
to unfreeze its local file system;
and further wherein at least one said application server is configured to be responsive to a point-in-time (PTC) request from a client to signal, via said network, for each application server to freeze its local file system, to create a PTC of the metadata of its local file system, and to unfreeze its local file system.

29. An apparatus in accordance with claim 28 further configured to select and utilize one of the clustered application servers to synchronize the freezing of the local file systems, the creating of the copy of the metadata, and the unfreezing of the local file systems, the utilized application server thereby becoming a synchronizing server.

30. An apparatus in accordance with claim 29 further configured to reject or stall newly received requests from clients to update user data stored on the local file systems while the local file systems are frozen.

31. An apparatus in accordance with claim 29 further configured to at least one of service or flush requests from clients to update user data stored on the local file systems pending at a time when the local file systems are frozen.

32. An apparatus in accordance with claim 29 further configured to receive a request from a client to, update user data while the local file systems are unfrozen, to update the local file systems and metadata of one or more of the application servers in accordance with the update request utilizing unallocated memory in the local file systems, and to retain unaltered user data in portions of the local file systems allocated at the time the local file systems were frozen and an unaltered PTC of the metadata of the file systems.

33. An apparatus in accordance with claim 29 wherein the user data comprises files, and said apparatus is configured to divide at least some of the files into segments to further subdivide the segments into portions of segments, and store portions of the segments across more than one said application server.

34. An apparatus in accordance with claim 33 further configured to determine a checksum for each said segment, and to store said checksum in a file system of an application server exclusive of the portions of the segment for which the checksum was determined.

35. An apparatus in accordance with claim 34 wherein the number of application servers is N, and the number of portions in each said segment that is not a final segment is N−1.

36. An apparatus in accordance with claim 35 further configured to rotate the storing of said checksums for consecutive said segments amongst said N application servers.

37. An apparatus in accordance with claim 29 further configured to retain user data stored when a PTC request is received at locations in the file systems at which the retained user data is already stored, and to store further updated user data in location in the file system different from those of the retained user data.

38. An apparatus for storing updatable user data and for providing client access to an application, said apparatus comprising:
a plurality of application servers interconnected via a network, each said application server having an associated local storage device on which resides a local file system; and
a router/switch configured to route requests received from clients to said application servers via said network;
wherein at least one said application server is a point-in-time copy (PTC) managing server and a plurality of remaining application servers are non-managing servers;
and further wherein said PTC managing server is configured to retain a local copy of metadata pertaining to user data stored in said non-managing application servers of said cluster in a memory local to said PTC managing server;
said apparatus is configured to store updatable user data across a plurality of said non-managing application servers in file systems of associated local storage devices;
said non-managing application servers are configured to manage a local copy of metadata pertaining to user data stored on the file system of the associated local storage device; and
said apparatus is further configured to receive a PTC request from a client and to create a PTC of the metadata in the PTC managing server.

39. An apparatus in accordance with claim 38 further configured to route update requests transmitted from clients and answers from said application servers via an Ethernet network, and to transmit and receive metadata information relating to the update requests between the non-managing application servers and the PTC managing application server via the same Ethernet network.

40. An apparatus in accordance with claim 38 wherein the user data comprises files, and to store updatable user data across a plurality of said non-managing application servers, said apparatus is configured to divide at least some files into a plurality of segments, and to store portions of said segments across more than one said non-managing applications server.

41. An apparatus in accordance with claim 40 further configured to determine a checksum for each said segment, and to store said checksum in the file system of a non-managing application server exclusive of the portions of the segment for which the checksum was determined.

42. An apparatus in accordance with claim 41 wherein the number of non-managing application servers is N, and the number of portions in each said segment that is not a final segment is N−1.

43. An apparatus in accordance with claim 42 further configured to rotate the storing of said checksums for consecutive said segments amongst the N non-managing application servers.
